(19) United States
(12) Patent Application Publication
(10) Pub. No.: US 2020/0029062 A1
(43) Pub. Date: Jan. 23, 2020

(54) COLOR TEMPERATURE ADJUSTMENT METHOD AND DEVICE, DISPLAY APPARATUS, COMPUTER READABLE STORAGE MEDIUM AND COMPUTER PROGRAM PRODUCT

(71) Applicants: K-TRONICS (SUZHOU) TECHNOLOGY CO., LTD., Suzhou, Jiangsu (CN); BOE TECHNOLOGY GROUP CO., LTD., Beijing (CN)

(72) Inventor: Rongrong SHI, Beijing (CN)

(21) Appl. No.: 16/337,993

(22) PCT Filed: Aug. 7, 2018
(86) PCT No.: PCT/CN2018/099134

§ 371 Date: Mar. 29, 2019

(30) Foreign Application Priority Data
Aug. 9, 2017 (CN) 201710676428.1

(51) Int. Cl. H04N 9/73; G09G 5/02

(52) U.S. Cl. CPC H04N 9/73; G09G 2320/0666; G09G 5/026

(57) ABSTRACT

A color temperature adjustment method and device used for a display apparatus, a display apparatus, a non-volatile computer readable storage medium, and a computer program product. The color temperature adjustment method comprises the steps of: acquiring the film source color temperature information of a film source to be displayed; determining a color temperature adjustment parameter according to the film source color temperature information and the body color temperature information of the display apparatus; and adjusting the body color temperature of the display apparatus to a film source color temperature corresponding to the film source color temperature information according to the color temperature adjustment parameter.

### CROSS REFERENCE TO RELATED APPLICATIONS

The present application is the U.S. national phase entry of PCT/CN2018/099134, with an international filing date of Aug. 7, 2018, which claims the priority of Chinese Patent Application No. 201710676428.1 filed on Aug. 9, 2017, the content of which are incorporated herein by reference in their entireties.

### TECHNICAL FIELD

The present disclosure relates to the field of display technologies, and more particularly to a color temperature adjustment method and device used for a display apparatus, a display apparatus, a computer readable storage medium and a computer program product.

### BACKGROUND

With the development of science and technology, more and more display apparatuses have entered into people's lives, and users set higher and higher requirements for the display effects of these display apparatuses. How to improve the image restoration degree of film sources and therefore the display quality thereof is still an urgent technical problem to be solved by those having ordinary skill in the art.

### SUMMARY

A color temperature adjustment method used for a display apparatus provided by an exemplary embodiment comprises the steps of:

acquiring the film source color temperature information of a film source to be displayed;

determining a color temperature adjustment parameter according to the film source color temperature information and the body color temperature information of the display apparatus; and

adjusting the body color temperature of the display apparatus to a film source color temperature corresponding to the film source color temperature information according to the color temperature adjustment parameter.

In some exemplary embodiments, the step of acquiring the film source color temperature information of a film source to be displayed comprises: if the film source consists of a frame picture, acquiring the film source color temperature information of the picture.

In some exemplary embodiments, the step of acquiring the film source color temperature information of a film source to be displayed comprises: if the film source consists of a plurality of frames of pictures, selecting a frame of picture to be displayed from the film source and acquiring the film source color temperature information of the picture.

In some exemplary embodiments, the step of determining a color temperature adjustment parameter according to the film source color temperature information and the body color temperature information of the display apparatus comprises:

if the film source color temperature information and the body color temperature information are both RGB values, comparing the RGB value of the film source with the RGB value of the display apparatus and using the difference between the two RGB values as the color temperature adjustment parameter.

In some exemplary embodiments, the step of determining a color temperature adjustment parameter according to the film source color temperature information and the body color temperature information of the display apparatus comprises:

if the film source color temperature information and the body color temperature information are both color coordinate values, comparing the color coordinate value of the film source with the color coordinate value of the display apparatus and converting the difference between the two color coordinate values into the difference of the RGB values that is used as the color temperature adjustment parameter. In an exemplary embodiment, the color coordinate value of the film source color temperature information and the color coordinate value of the body color temperature information are respectively converted into RGB values and the difference between the two RGB values is used as the color temperature adjustment parameter.

In some exemplary embodiments, the step of determining a color temperature adjustment parameter according to the film source color temperature information and the body color temperature information of the display apparatus comprises:

if one of the film source color temperature information and the body color temperature information is an RGB value and the other thereof is a color coordinate value, converting the color coordinate value into an RGB value, making a comparison with the non-converted RGB value, and using the difference between the two RGB values as the color temperature adjustment parameter.

In some exemplary embodiments, the step of adjusting the body color temperature of the display apparatus to a film source color temperature corresponding to the film source color temperature information according to the color temperature adjustment parameter comprises:

according to the color temperature adjustment parameter, adjusting the body color temperature of the display apparatus to a film source color temperature corresponding to the film source color temperature information by adjusting the RGB value of the display apparatus.

In some exemplary embodiments, before the step of determining a color temperature adjustment parameter according to the film source color temperature information and the body color temperature information of the display apparatus, the method further comprises:

acquiring and storing the body color temperature information of the display apparatus.

A color temperature adjustment device used for a display apparatus provided by an embodiment of the present disclosure comprises:

a color temperature recognition module configured to acquire the film source color temperature information of a film source to be displayed;

a color temperature adjustment module configured to determine a color temperature adjustment parameter according to the film source color temperature information and the body color temperature information of the display apparatus; and adjust the body color temperature of the display apparatus to a film source color temperature corresponding to the film source color temperature information according to the color temperature adjustment parameter.

In some exemplary embodiments, the color temperature recognition module is configured to:

if the film source consists of a frame of picture, acquire the film source color temperature information of the picture.

In some exemplary embodiments, the color temperature recognition module is configured to:

if the film source consists of a plurality of frames of pictures, select a frame of picture to be displayed from the film source and acquire the film source color temperature information of the picture.

In some exemplary embodiments, the color temperature adjustment module is configured to:

if the film source color temperature information and the body color temperature information are both RGB values, compare the RGB value of the film source with the RGB value of the display apparatus and use the difference between the two RGB values as the color temperature adjustment parameter.

In some exemplary embodiments, the color temperature adjustment module is configured to:

if the film source color temperature information and the body color temperature information are both color coordinate values, compare the color coordinate value of the film source with the color coordinate value of the display apparatus and convert the difference between the two color coordinate values into the difference of the RGB values that is used as the color temperature adjustment parameter.

In some exemplary embodiments, the color temperature adjustment module is configured to:

if one of the film source color temperature information and the body color temperature information is an RGB value and the other thereof is a color coordinate value, convert the color coordinate value into an RGB value, make a comparison with the non-converted RGB value, and use the difference between the two RGB values as the color temperature adjustment parameter.

In some exemplary embodiments, the color temperature adjustment module is configured to:

according to the color temperature adjustment parameter, adjust the body color temperature of the display apparatus to a film source color temperature corresponding to the film source color temperature information by adjusting the RGB value of the display apparatus.

In some exemplary embodiments, the color temperature adjustment device further comprises: a body color temperature information acquisition module and a storage module;

wherein the body color temperature information acquisition module is configured to acquire the body color temperature information of the display apparatus, and the storage module is configured to store the body color temperature information.

A display apparatus provided by an exemplary embodiment comprises a color temperature adjustment device provided by any embodiment of the present disclosure.

A non-volatile computer readable storage medium provided by an exemplary embodiment has a computer program stored thereon, which, when executed by a processor, implements a color temperature adjustment method provided by any embodiment of the present disclosure.

A computer program product provided by an exemplary embodiment comprises executable codes stored on a computer readable storage medium and configured to, when executed, implement a color temperature adjustment method provided by any embodiment of the present disclosure.

### BRIEF DESCRIPTION OF THE DRAWINGS

FIG. 1 is a flowchart schematic view of a color temperature adjustment method used for a display apparatus provided by an exemplary embodiment;

FIG. 2 is an overall flowchart schematic view of color temperature adjustment provided by an exemplary embodiment;

FIG. 3 is a structural schematic view of a color temperature adjustment device used for a display apparatus provided by an exemplary embodiment; and

FIG. 4 is a structural schematic view of another color temperature adjustment device used for a display apparatus provided by an exemplary embodiment.

### DETAILED DESCRIPTION

When a display apparatus is used to display a film source (such as a picture or video), because the body color temperature of the display apparatus is usually inconsistent with the film source color temperature of the film source (i.e., the color temperature of a photographic apparatus when the photographic apparatus is shooting the film source), the film source displayed by the display apparatus is often not represented (restored) accurately, thus affecting the display quality of the film source. In order to solve this problem, the body color temperature of the display apparatus is usually adjusted to a fixed color temperature value when the film source is displayed. Although the image restoration degree of the film source can be improved to some extent, the effect is still unsatisfactory. To this end, exemplary embodiments provide a color temperature adjusting method and device used for a display apparatus, and a display apparatus, which are used to improve the image restoration degree of a film source and thereby improve the display quality of the film source.

The technical solutions in exemplary embodiments will be clearly and fully described below in conjunction with the drawings in the exemplary embodiments. It should be understood that the described embodiments are only a part of the embodiments, and not all of the embodiments. All of other embodiments obtained by those having ordinary skill in the art based on the exemplary embodiments disclosed herein are within the protection scope of the present disclosure.

With reference to FIG. 1, a color temperature adjustment method used for a display apparatus provided by an exemplary embodiment comprises the following steps:

S101: Acquiring the film source color temperature information of a film source to be displayed.

The film source color temperature information refers to information which may be indicative of the film source color temperature of a film source. For instance, the film source color temperature information may comprise a RGB value or a color coordinate value. Since there is a correspondence between a color temperature and a RGB value or a color coordinate value, the film source color temperature of a film source may be acquired according to the film source color temperature information. For instance, a color temperature of 5400K corresponds to the color coordinates x=0.335, y=0.343.

Generally speaking, the film source color temperature information is included in an exchangeable image file (EXIF) of an image, and may be acquired by reading EXIF information.

S102: Determining a color temperature adjustment parameter according to the film source color temperature information and the body color temperature information of the display apparatus.

The body color temperature information refers to information which may be indicative of the body color temperature of a display apparatus. For instance, the body color temperature information may comprise a RGB value or a color coordinate value.

A display apparatus refers to any apparatus which may be used for displaying a film source, such as a TV set.

S103: Adjusting the body color temperature of the display apparatus to a film source color temperature corresponding to the film source color temperature information according to the color temperature adjustment parameter.

By this method, the body color temperature of the display apparatus may be adjusted to the film source color temperature of a film source to be displayed. Namely, the color temperature of the display apparatus when displaying a film source varies with the film source color temperature of the film source. Thus, when a film source is displayed by the display apparatus, the film source can be well restored, thereby improving the display quality of the film source.

In an exemplary embodiment, the step S101 of acquiring the film source color temperature information of a film source to be displayed may specifically comprise:

if the film source consists of a frame of picture, acquiring the film source color temperature information of the picture.

Since different pictures when being shot may have different film source color temperatures, in an exemplary embodiment, the step S101 of acquiring the film source color temperature information of a film source to be displayed may also specifically comprise:

if the film source consists of a plurality of frames of pictures, selecting a frame of picture to be displayed from the film source and acquiring the film source color temperature information of the picture.

For instance, if the film source consists of a plurality of frames of pictures, then acquire the film source color temperature information of each frame of the plurality of frames of pictures. Thus, each frame of picture of the film source can be better restored.

By the above-mentioned method, when each frame of picture is displayed, the body color temperature of the display apparatus is adjusted to the film source color temperature of the picture. Thus, when the film source is displayed by the display apparatus, the actual scenes can be better stored, thereby further improving the display quality of the film source.

In an exemplary embodiment, after acquiring the film source color temperature information of the film source, the method may further comprise:

storing the film source color temperature information.

In an exemplary embodiment, the step S102 of determining a color temperature adjustment parameter according to the film source color temperature information and the body color temperature information of the display apparatus may specifically comprise:

if the film source color temperature information and the body color temperature information are both RGB values, comparing the RGB value of the film source with the RGB value of the display apparatus and using the difference between the two RGB values as the color temperature adjustment parameter.

In an exemplary embodiment, the step S102 of determining a color temperature adjustment parameter according to the film source color temperature information and the body color temperature information of the display apparatus may specifically comprise:

if the film source color temperature information and the body color temperature information are both color coordinate values, comparing the color coordinate value of the film source with the color coordinate value of the display apparatus and converting the difference between the two color coordinate values into the difference of the RGB values that is used as the color temperature adjustment parameter.

In an exemplary embodiment, the color coordinate value of the film source color temperature information and the color coordinate value of the body color temperature information are respectively converted into RGB values, and the difference between the two RGB values is used as the color temperature adjustment parameter.

In an exemplary embodiment, the step S102 of determining a color temperature adjustment parameter according to the film source color temperature information and the body color temperature information of the display apparatus may specifically comprise:

if one of the film source color temperature information and the body color temperature information is an RGB value and the other thereof is a color coordinate value, converting the color coordinate value into an RGB value, making a comparison with the non-converted RGB value, and using the difference between the two RGB values as the color temperature adjustment parameter.

In an exemplary embodiment, the step S103 of adjusting the body color temperature of the display apparatus to a film source color temperature corresponding to the film source color temperature information according to the color temperature adjustment parameter may specifically comprise:

according to the color temperature adjustment parameter, adjusting the body color temperature of the display apparatus to a film source color temperature corresponding to the film source color temperature information by adjusting the RGB value of the display apparatus.

It should be explained that the present disclosure may use the RGB value as the color temperature adjustment parameter, and adjust the body color temperature of the display apparatus to the film source color temperature by adjusting the RGB value of the display apparatus. Of course, it may also use another value as the color temperature adjustment parameter, such as the color coordinate value, and achieve the purpose of adjusting the body color temperature of the display apparatus to the film source color temperature through a corresponding conversion before displaying the film source, which will not be limited by the exemplary embodiments disclosed herein.

In an exemplary embodiment, before the step of determining a color temperature adjustment parameter according to the film source color temperature information and the body color temperature information of the display apparatus, the method may further comprise:

acquiring and storing the body color temperature information of the display apparatus.

For instance, the display apparatus may be measured by a color analyzer so as to acquire the body color temperature information of the display apparatus.

Of course, the body color temperature information of the display apparatus may also be pre-measured and stored, so that it may be invoked when adjusting the color temperature.

It should be pointed out that the color temperature adjustment method provided by an exemplary embodiment is used to adjust the color temperature of the display apparatus before the display apparatus displays the film source, so as to improve the image restoration degree of the film source and thereby the display quality of the film source.

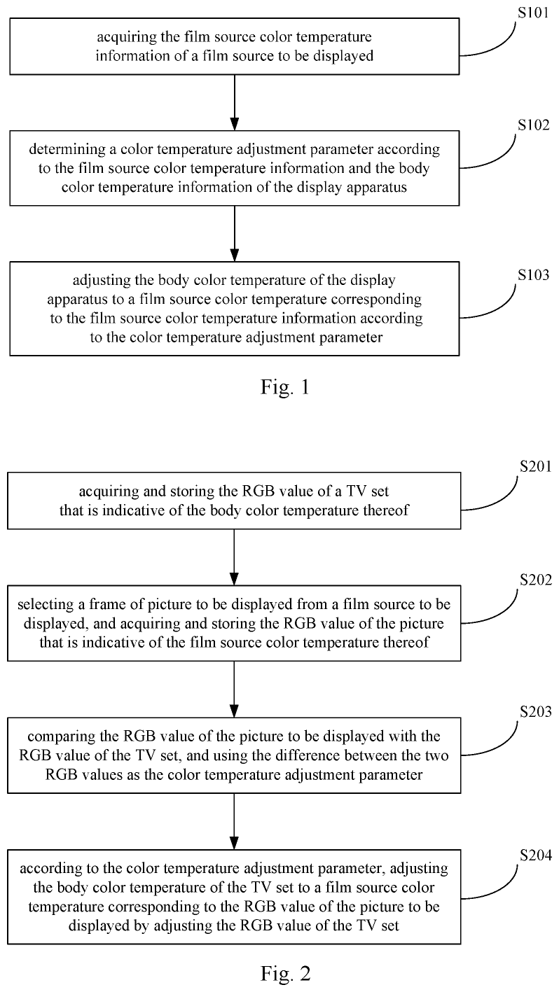

To sum up, the overall flow process of the color temperature adjustment in the embodiment of the present disclosure will be explained with reference to FIG. 2 by taking a TV set which displays a film source including a plurality of frames of pictures as an example:

S201: acquiring and storing the RGB value of a TV set that is indicative of the body color temperature thereof;

S202: selecting a frame of picture to be displayed from a film source to be displayed, and acquiring and storing the RGB value of the picture that is indicative of the film source color temperature thereof;

S203: comparing the RGB value of the picture to be displayed with the RGB value of the TV set, and using the difference between the two RGB values as the color temperature adjustment parameter;

S204: according to the color temperature adjustment parameter, adjusting the body color temperature of the TV set to a film source color temperature corresponding to the RGB value of the picture to be displayed by adjusting the RGB value of the TV set.

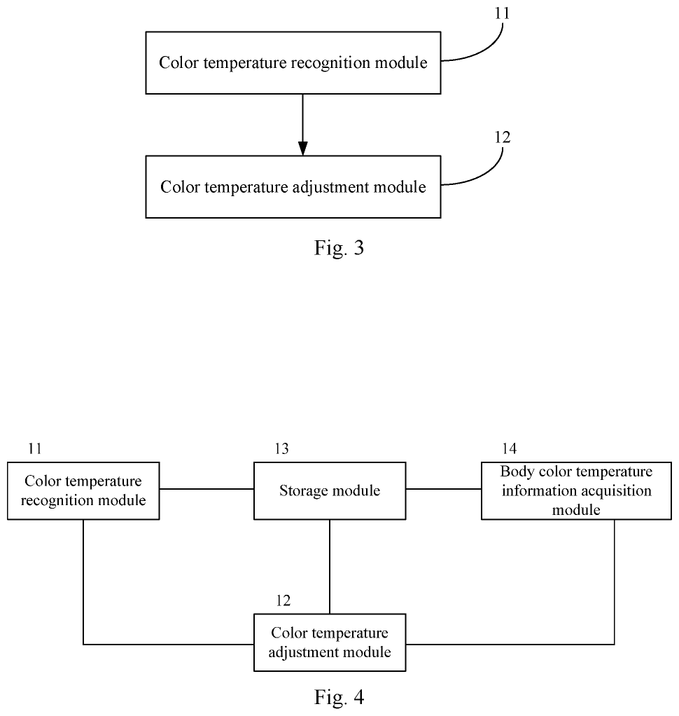

With reference to FIG. 3, based on the same inventive concept, the exemplary embodiment also provides a color temperature adjustment device used for a display apparatus, which comprises:

a color temperature recognition module 11 configured to acquire the film source color temperature information of a film source to be displayed;

a color temperature adjustment module 12 configured to determine a color temperature adjustment parameter according to the film source color temperature information and the body color temperature information of the display apparatus; and adjust the body color temperature of the display apparatus to a film source color temperature corresponding to the film source color temperature information according to the color temperature adjustment parameter.

In an exemplary embodiment, the color temperature recognition module 11 is specifically configured to:

if the film source consists of a frame of picture, acquire the film source color temperature information of the picture; or

if the film source consists of a plurality of frames of pictures, select a frame of picture to be displayed from the film source and acquire the film source color temperature information of the picture.

In an exemplary embodiment, the color temperature adjustment module 12 may be specifically configured to:

if the film source color temperature information and the body color temperature information are both RGB values, compare the RGB value of the film source with the RGB value of the display apparatus and use the difference between the two RGB values as the color temperature adjustment parameter; or

if the film source color temperature information and the body color temperature information are both color coordinate values, compare the color coordinate value of the film source with the color coordinate value of the display apparatus and convert the difference between the two color coordinate values into the difference of the RGB values that is used as the color temperature adjustment parameter; or

if one of the film source color temperature information and the body color temperature information is an RGB value and the other thereof is a color coordinate value, convert the color coordinate value into an RGB value, make a comparison with the non-converted RGB value, and use the difference between the two RGB values as the color temperature adjustment parameter.

In an exemplary embodiment, the color temperature adjustment module 12 may be specifically configured to:

according to the color temperature adjustment parameter, adjust the body color temperature of the display apparatus to a film source color temperature corresponding to the film source color temperature information by adjusting the RGB value of the display apparatus.

In an exemplary embodiment, as shown in FIG. 4, the color temperature adjustment device may further comprise: a storage module 13 which may be configured to store the film source color temperature information.

In an exemplary embodiment, as shown in FIG. 4, the color temperature adjustment device may further comprise: a body color temperature information acquisition module 14 configured to acquire the body color temperature information of the display apparatus; and

the storage module 13 which may be further configured to store the body color temperature information.

Based on the same inventive concept, some exemplary embodiments also provide a display apparatus, which comprises: a color temperature adjustment device provided by any embodiment of the present disclosure. The display apparatus may be any product or component having a display function, such as a mobile phone, a tablet, a TV set, a display, a laptop computer, a digital photo frame, or a navigator.

Based on the same inventive concept, some exemplary embodiments also provide a non-volatile computer readable storage medium, on which a computer program is stored, wherein the computer program, when executed by a processor, implements a color temperature adjustment method provided by any embodiment.

Based on the same inventive concept, some exemplary embodiments also provide a computer program product, which comprises executable codes stored on the computer readable storage medium and configured to, when executed, implement a color temperature adjustment method provided by any embodiment.

In summary, the technical solution provided by exemplary embodiments may adjust the body color temperature of the display apparatus to the film source color temperature of a film source to be displayed by acquiring the film source color temperature information of the film source to be displayed; determining a color temperature adjustment parameter according to the film source color temperature information and the body color temperature information of the display apparatus; and adjusting the body color temperature of the display apparatus to a film source color temperature corresponding to the film source color temperature information according to the color temperature adjustment parameter. Thus, when a film source is displayed by the display apparatus, the film source can be well restored, thereby improving the display quality of the film source.

Those having ordinary skill in the art will appreciate that the embodiments may be provided as a method, a system or a computer program product. Thus, embodiments may take the form of an entire hardware embodiment, an entire software embodiment, or an embodiment combining software and hardware aspects. Moreover, exemplary may take the form of a computer program product embodied in one or more computer usable storage mediums (including, but not limited to, a magnetic disk storage and an optical storage, etc.) including computer usable program codes.

The exemplary embodiments are described with reference to flowcharts and/or block diagrams of methods, apparatus (systems), and computer program products according to the exemplary embodiment described. It will be understood that each flow and/or block of the flowcharts and/or block diagrams, and combinations of flows and/or blocks in the flowcharts and/or block diagrams, may be implemented by computer program instructions. These computer program instructions may be provided to a general purpose computer, a special purpose computer, an embedded processing machine, or a processor of other programmable data processing apparatus to produce a machine, so that instructions executed by a computer or a processor of other programmable data processing apparatus produce a device for implementing the functions specified in one or more flows of the flowcharts and/or in one or more blocks of the block diagrams.

The computer program instructions may also be stored in a computer readable storage which can boot a computer or other programmable data processing apparatus to operate in a specific way, so that the instructions stored in the computer readable storage produce a device which implements the functions specified in one or more flows of the flowcharts and/or in one or more blocks of the block diagrams.

The computer program instructions may also be loaded onto a computer or other programmable data processing apparatus to cause a series of operational steps to be performed on the computer or other programmable apparatus to produce a computer-implemented process, such that the instructions that are executed on the computer or other programmable apparatus provide steps for implementing the functions specified in one or more flows of the flowcharts and/or in one or more blocks of the block diagrams.

It will be understood that various modifications and variations of the present disclosure may be made by those having ordinary skill in the art without departing from the spirit and scope of the disclosure. Thus, it is intended that the present disclosure also covers these modifications and variations as long as these modifications and variations of the present disclosure are within the scope of the appended claims of the present disclosure and their equivalents.

1. A color temperature adjustment method used for a display apparatus, comprising the steps of:
acquiring the film source color temperature information of a film source to be displayed;
determining a color temperature adjustment parameter according to the film source color temperature information and the body color temperature information of the display apparatus; and
adjusting the body color temperature of the display apparatus to a film source color temperature corresponding to the film source color temperature information according to the color temperature adjustment parameter.

2. The color temperature adjustment method according to claim 1, wherein the step of acquiring the film source color temperature information of a film source to be displayed comprises:
if the film source consists of a frame of picture, acquiring the film source color temperature information of the picture.

3. The color temperature adjustment method according to claim 1, wherein the step of acquiring the film source color temperature information of a film source to be displayed comprises:
if the film source consists of a plurality of frames of pictures, selecting a frame of picture to be displayed from the film source and acquiring the film source color temperature information of the picture.

4. The color temperature adjustment method according to claim 1, wherein the step of determining a color temperature adjustment parameter according to the film source color temperature information and the body color temperature information of the display apparatus comprises:
if the film source color temperature information and the body color temperature information are both RGB values, comparing the RGB value of the film source with the RGB value of the display apparatus and using the difference between the two RGB values as the color temperature adjustment parameter.

5. The color temperature adjustment method according to claim 1, wherein the step of determining a color temperature adjustment parameter according to the film source color temperature information and the body color temperature information of the display apparatus comprises:
if the film source color temperature information and the body color temperature information are both color coordinate values, comparing the color coordinate value of the film source with the color coordinate value of the display apparatus and converting the difference between the two color coordinate values into the difference of the RGB values that is used as the color temperature adjustment parameter.

6. The color temperature adjustment method according to claim 5, wherein the step of determining a color temperature adjustment parameter according to the film source color temperature information and the body color temperature information of the display apparatus comprises:
respectively converting the color coordinate value of the film source color temperature information and the color coordinate value of the body color temperature information into RGB values, and using the difference between the two RGB values as the color temperature adjustment parameter.

7. The color temperature adjustment method according to claim 1, wherein the step of determining a color temperature adjustment parameter according to the film source color temperature information and the body color temperature information of the display apparatus comprises:
if one of the film source color temperature information and the body color temperature information is an RGB value and the other thereof is a color coordinate value, converting the color coordinate value into an RGB value, making a comparison with the non-converted RGB value, and using the difference between the two RGB values as the color temperature adjustment parameter.

8. The color temperature adjustment method according to claim 4, wherein the step of adjusting the body color temperature of the display apparatus to a film source color temperature corresponding to the film source color temperature information according to the color temperature adjustment parameter comprises:
according to the color temperature adjustment parameter, adjusting the body color temperature of the display apparatus to a film source color temperature corresponding to the film source color temperature information by adjusting the RGB value of the display apparatus.

9. The color temperature adjustment method according to claim 1, wherein before the step of determining a color temperature adjustment parameter according to the film source color temperature information and the body color temperature information of the display apparatus, the method further comprises:
acquiring and storing the body color temperature information of the display apparatus.

10. A color temperature adjustment device used for a display apparatus, comprising:
a color temperature recognition module configured to acquire the film source color temperature information of a film source to be displayed;
a color temperature adjustment module configured to determine a color temperature adjustment parameter according to the film source color temperature information and the body color temperature information of the display apparatus, and adjust the body color temperature of the display apparatus to a film source color temperature corresponding to the film source color temperature information according to the color temperature adjustment parameter.

11. The color temperature adjustment device according to claim 10, wherein the color temperature recognition module is configured to:
if the film source consists of a frame picture, acquire the film source color temperature information of the picture.

12. The color temperature adjustment device according to claim 10, wherein the color temperature recognition module is configured to:
if the film source consists of a plurality of frames of pictures, select a frame of picture to be displayed from the film source and acquire the film source color temperature information of the picture.

13. The color temperature adjustment device according to claim 10, wherein the color temperature adjustment module is configured to:
if the film source color temperature information and the body color temperature information are both RGB values, compare the RGB value of the film source with the RGB value of the display apparatus and use the difference between the two RGB values as the color temperature adjustment parameter.

14. The color temperature adjustment device according to claim 10, wherein the color temperature adjustment module is configured to:
if the film source color temperature information and the body color temperature information are both color coordinate values, compare the color coordinate value of the film source with the color coordinate value of the display apparatus and convert the difference between the two color coordinate values into the difference of the RGB values that is used as the color temperature adjustment parameter.

15. The color temperature adjustment device according to claim 10, wherein the color temperature adjustment module is configured to:
if one of the film source color temperature information and the body color temperature information is an RGB value and the other thereof is a color coordinate value, convert the color coordinate value into an RGB value, make a comparison with the non-converted RGB value, and use the difference between the two RGB values as the color temperature adjustment parameter.

16. The color temperature adjustment device according to claim 13, wherein the color temperature adjustment module is configured to:
according to the color temperature adjustment parameter, adjust the body color temperature of the display apparatus to a film source color temperature corresponding to the film source color temperature information by adjusting the RGB value of the display apparatus.

17. The color temperature adjustment device according to claim 10, further comprising: a body color temperature information acquisition module and a storage module;
wherein the body color temperature information acquisition module is configured to acquire the body color temperature information of the display apparatus, and the storage module is configured to store the body color temperature information.

18. A display apparatus, comprising a color temperature adjustment device according to claim 10.

19. A non-volatile computer readable storage medium having a computer program stored thereon, which, when executed by a processor, implements a color temperature adjustment method according to claim 1.

20. A computer program product, comprising executable codes stored on a computer readable storage medium and configured to, when executed, implement a color temperature adjustment method according to claim 1.
